(19) United States
(12) Patent Application Publication
(10) Pub. No.: US 2003/0066162 A1
(43) Pub. Date: Apr. 10, 2003

(54) Shock-absorbing caster of traveling suitcase

(76) Inventor: Chung-Hsien Kuo, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/973,010

(22) Filed: Oct. 10, 2001

(51) Int. Cl. B60B 33/00

(52) U.S. Cl. 16/44

(57) ABSTRACT

The present invention provides a shock-absorbing caster structure of traveling suitcase comprising a caster shell seat, a roller pivotal seat, a roller, and a soft component (or a resilient body). The caster shell seat is fixedly disposed at the bottom edge of the rear side of a traveling suitcase. The caster shell seat is pivotally joined with a protuberance at the top of an arc-shaped top plate of the roller pivotal seat. The arc-shaped top plate is joined with one side of the soft component or the resilient body. The other side of the soft component abuts against the inner edge of the caster shell seat. The roller is pivotally joined inside the roller pivotal seat. The soft component abuts against the inside of the caster shell seat to absorb vibration energy generated when the roller rolls on uneven ground so that a user can conveniently pull the traveling suitcase.

### FIELD OF THE INVENTION

The present invention relates to a shock-absorbing caster structure of traveling suitcase and, more particularly, to an improved shock absorbing caster structure capable of effectively enhancing shock-absorbing effect of a traveling suitcase so that a user can conveniently pull the traveling suitcase forwards.

### BACKGROUND OF THE INVENTION

As shown in FIG. 1, a conventional shock-absorbing caster structure of traveling suitcase comprises a caster shell seat 1, a roller pivotal seat 2, a roller 3, and a soft component 4. The caster shell seat 1 comprises a wheel cover 10 and a connection plate extending from the peripheral edge pf the wheel cover 10. The wheel cover 10 has a wheel-receiving space 100 therein. The caster shell seat 1 is locked at the edge of the bottom end of a traveling suitcase via the connection plate.

Moreover, the roller pivotal seat 2 comprises a top plate and two pivotal plates bent downwards from two sides of the top plate. Front and rear ends of the two pivotal plates have pivotal holes 24 and 26, respectively. The pivotal hole 26 at the front end is used for pivotally joining the roller 3. The pivotal hole 24 at the rear end is used to connect the soft component 40, and utilizes a pivotal element to pivotally join the caster shell seat 1.

The soft component 40 abuts against and is matched between the edge face of the wheel cover 10 at the upper end of the wheel-receiving space 100 and the top plate of the roller pivotal seat 2. The soft component 40 is used to absorb vibration energy generated when the roller 3 rolls on uneven ground, hence enhancing shock-absorbing effect of the whole traveling suitcase.

The pivotal hole 26 at the rear end of the roller pivotal seat 2 is used to connect the soft component 40, and utilizes a pivotal element to pivotally join the caster shell seat 1. When a user uses the traveling suitcase, it is difficult for him to push the traveling suitcase forwards because of influence of reaction force. Moreover, the roller 3 will easily touch the pivotal hole 26 due to influence of longtime action force, hence resulting in deformation and damage of the pivotal element.

Furthermore, in order to prevent from affecting forward course of the user, a traveling suitcase needs to be pulled forwards. Additionally, a forwards-pulled traveling suitcase can enhance convenience in use. Therefore, the above design does not conform to human engineering and needs to be improved.

Accordingly, the above shock-absorbing caster structure of traveling suitcase has inconvenience and drawbacks in practical use. The present invention aims to resolve the problems in the prior art.

### SUMMARY OF THE INVENTION

The primary object of the present invention is to move the pivotal holes upwards to the top of the arc-shaped top plate of the caster shell seat, and then dispose the soft component at the front side of the caster shell seat so that the soft component can abut against and be matched between the edge face inside the caster shell seat and the roller pivotal seat, thereby conquering influence of reaction force, avoiding too large vibration from pulling the traveling suitcase, and enhancing comfort of pulling the traveling suitcase. Therefore, the user can conveniently pull the traveling suitcase, and the object of human engineering can be achieved.

Another object of the present invention is to receive a resilient element in the soft component to absorb vibration energy generated when the roller rolls on uneven ground, thereby enhancing the whole shock-absorbing effect, protecting valuable articles in the traveling suitcase, and lengthening lifetime of use of the roller.

Yet another object of the present invention is to dispose the soft component and the resilient element at the front side of the caster shell seat to effectively absorb vibration force and prevent the roller from deformation and damage due to contacting the pivotal element for a long time.

To achieve the above objects, the present invention provides a shock-absorbing caster structure of traveling suitcase. The present invention mainly improves positions and connection ways of the caster shell seat, the roller pivotal seat, and the soft component in the prior art. The shock-absorbing caster structure of traveling suitcase of the present invention comprises a caster shell seat, a roller pivotal seat, a roller, and a soft component (or a resilient body). The caster shell seat has a plurality of projective poles thereon matched with screws or rivets to be fixedly disposed at the bottom edge of the rear side of the traveling suitcase. The caster shell seat has a receiving space therein to receive the roller pivotal seat. The roller pivotal seat comprises an arc-shaped top plate, a left side plate, and a right side plate. A rectangular protuberance is disposed at the top of the arc-shaped top plate. The top edge of the protuberance has a first pivotal hole to be passed through by a first pivot. The roller pivotal seat is pivotally disposed in the receiving space of the caster shell seat.

A mobile clamping groove is disposed at the bottom of the arc-shaped top plate to clamp two sides of the soft component. The center of the soft component forms a hollow flange. The flange abuts against the inner edge of the caster shell seat. The hollow flange can receive a resilient element. The left side plate and the right side plate can be passed through by a second pivot. The roller is pivotally disposed in the midst of the left side plate and the right side plate of the roller pivotal seat.

The various objects and advantages of the present invention will be more readily understood from the following detailed description when read in conjunction with the appended drawings, in which:

### BRIEF DESCRIPTION OF THE DRAWINGS:

FIG. 1 is a side cross-sectional view of a shock-absorbing caster structure of traveling suitcase in the prior art;

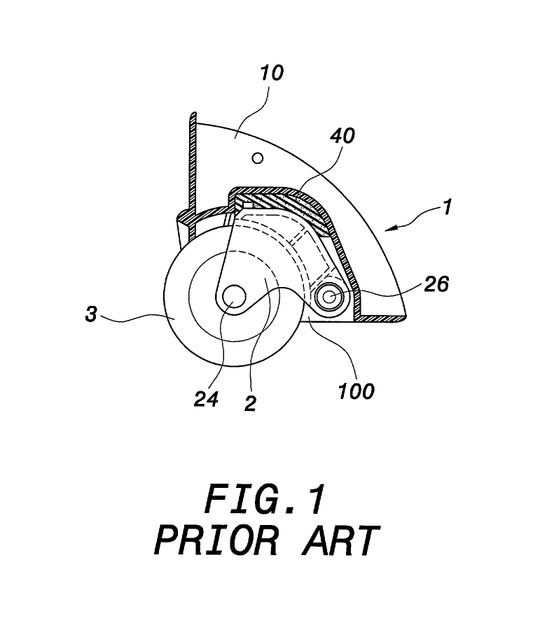

FIG. 2 is an exploded perspective view of the present invention;

FIG. 3 is a perspective view of the present invention;

FIG. 4 is a side cross-sectional view of the present invention;

FIG. 5 is a diagram showing the use state of the present invention;

FIG. 6 is an exploded perspective view according to another embodiment of the present invention; and

FIG. 7 is a cross-sectional view according to yet another embodiment of the present invention.

### DETAILED DESCRIPTION OF THE PREFERRED EMBODIMENTS

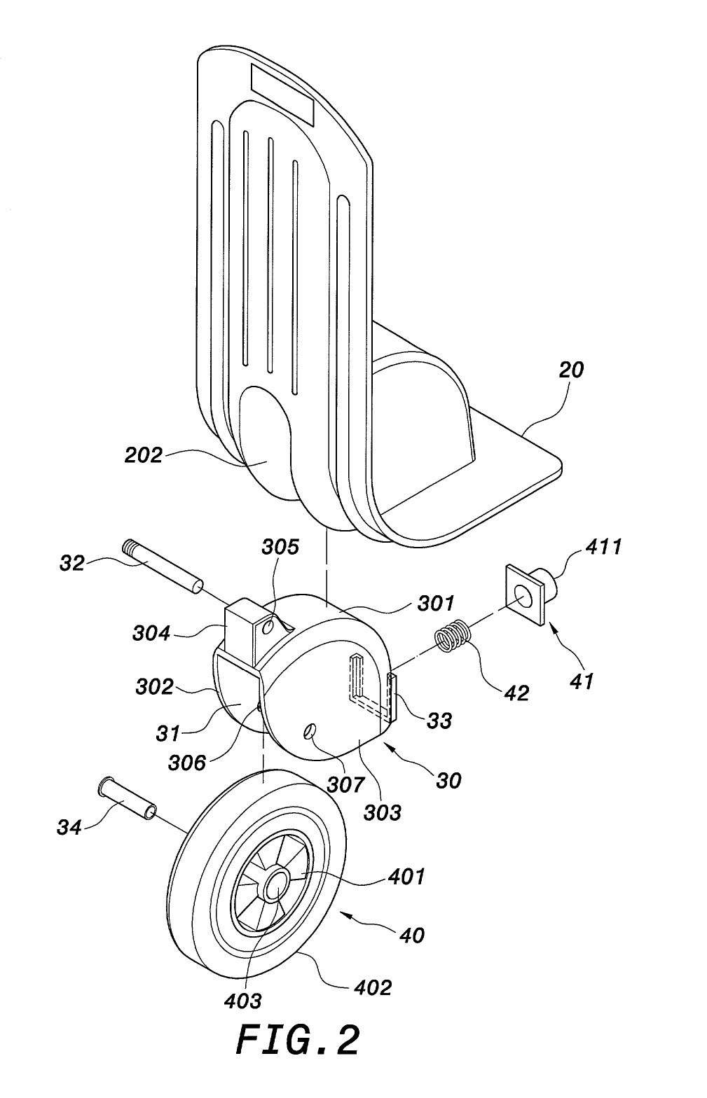

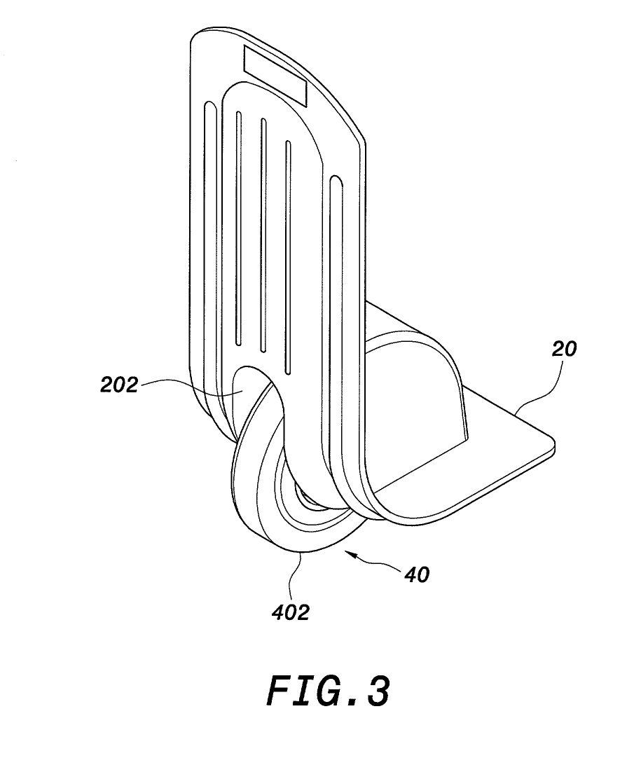

As shown in FIGS. 2 to 5, the present invention relates to a shock-absorbing caster structure of traveling suitcase and, more particularly, to an improved shock absorbing caster structure capable of effectively enhancing shock-absorbing effect of a traveling suitcase so that a user can conveniently pull the traveling suitcase forwards. The shock-absorbing caster structure of traveling suitcase of the present invention comprises a caster shell seat 20, a roller pivotal seat 30, a roller 40, and a soft component 41 (or a resilient body).

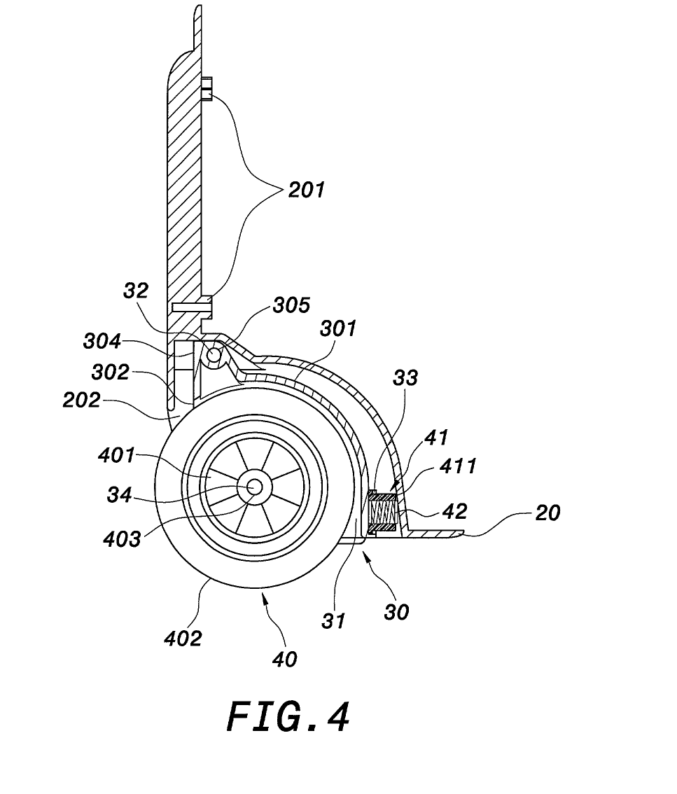

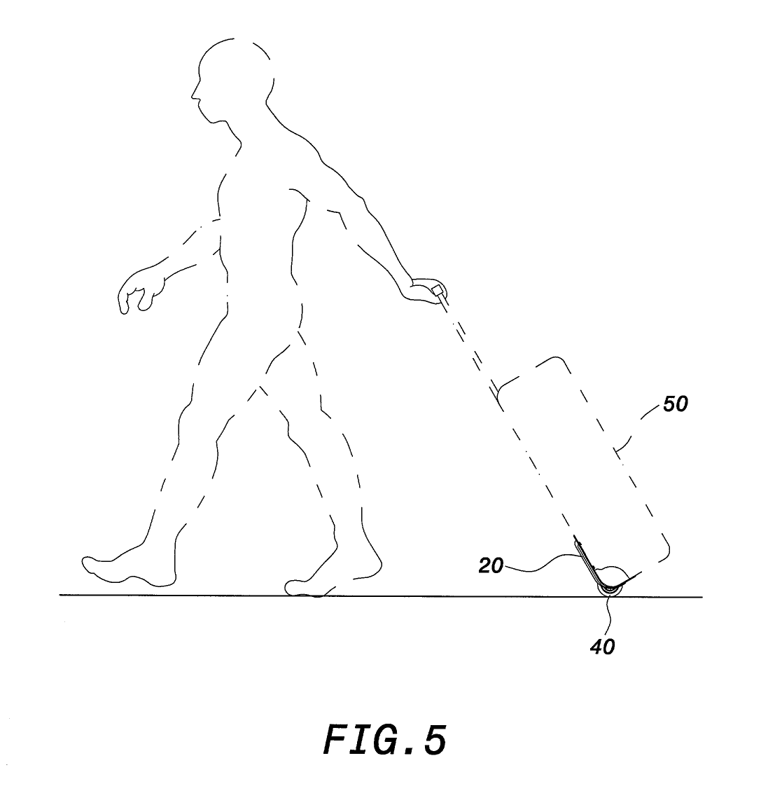

The caster shell seat 20 is roughly L-shaped. The caster shell seat 20 has a plurality of projective poles 201 thereon (as shown in FIG. 4) matched with fixing elements such as screws (not shown) or rivets (not shown) to be fixedly disposed at the bottom edge of the rear side of a traveling suitcase 50 (as shown in FIG. 5). The caster shell seat 20 has a receiving space 202 therein to receive the roller pivotal seat 30.

The roller pivotal seat 30 has a wheel-receiving space 301 therein to receive the roller 40. The roller pivotal seat 30 comprises an arc-shaped top plate 301, a left side plate 302, and a right side plate 303. The left and right side plates 301 and 302 are bent from two sides of the arc-shaped top plate 301. A rectangular protuberance 304 is disposed at the top of the arc-shaped top plate 301. The upper edge of the protuberance 304 has a first pivotal hole 305 to be passed through by a first pivot 32. The roller pivotal seat 30 is pivotally disposed in the receiving space 202 of the caster shell seat 20.

A mobile clamping groove 33 is disposed at the bottom of the arc-shaped top plate 301 to clamp two sides of the soft component 41 (or the resilient body). The soft component 41 can be made of soft material such as rubber. The resilient body is a spring. The soft component 41 or the resilient body can absorb vibration energy generated when the roller rolls 40 on uneven ground. The center of the soft component 41 forms a hollow flange 411. The flange 411 abuts against the inner edge of the caster shell seat 20 (as shown in FIG. 4). The hollow flange 411 can receive a resilient element 42 to further absorb vibration energy generated when the roller 40 rolls on uneven ground, hence enhancing shock-absorbing effect of the traveling suitcase 50.

The left side plate 302 of the roller pivotal seat 30 has a second pivotal hole 306, and the right side plate 303 of the roller pivotal seat 30 has a third pivotal hole 307. The second and third pivotal holes 306 and 307 match each other to be passed through by a second pivot 34. The roller 40 is pivotally disposed inside the wheel-receiving space 31 in the midst of the left side plate 302 and the right side plate 303 of the roller pivotal seat 30.

The roller 40 comprises a hub portion 401 and a felly portion 402 disposed at the periphery of the hub portion 401. The hub portion 401 has a central hole 403 to be passed by the second pivot 34. The roller 40 is pivotally disposed inside the wheel-receiving space 31 in the midst of the left side plate 302 and the right side plate 303 of the roller pivotal seat 30. The felly portion 402 is made of colloid material to further absorb vibration energy generated when the roller 40 rolls on uneven ground, hence enhancing shocking-absorbing effect of the traveling suitcase 50.

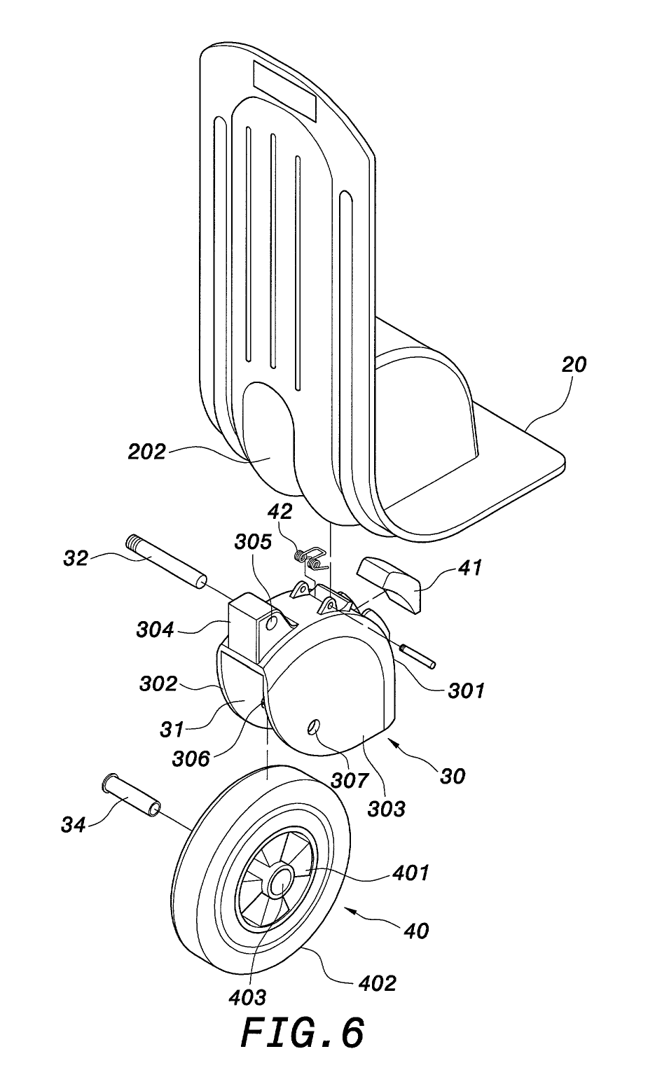

As shown in FIG. 6, the soft component 41 and the resilient element 42 can be disposed in turn on the arc-shaped top plate 301. One side of the soft component 41 and the resilient element 42 abuts against the inner edge of the caster shell seat 20 to further absorb vibration energy generated when the roller 40 rolls on uneven ground, hence enhancing shocking-absorbing effect of the traveling suitcase 50.

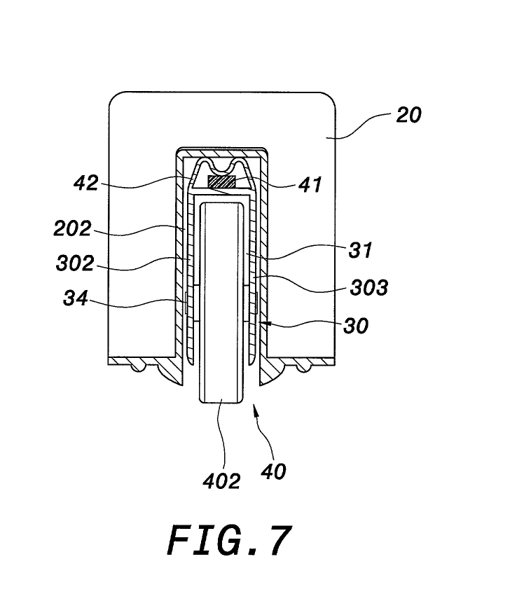

As shown in FIG. 7, the resilient element 42 can be integrally formed with the roller pivotal seat 30 to prevent the roller from vibrating too large when rolling on uneven ground. The connection and disposition ways of this embodiment are the same as those of the above first embodiment and thus will not be further described.

To sum up, the shock-absorbing caster structure of traveling suitcase of the present invention has at least the following merits.

1. The protuberance 304 of the roller pivotal seat 30 is moved upwards to the top of the arc-shaped top plate 301, and the soft component 41 abuts against the lower portion of the inner edge face of the caster shell seat 20 to conquer the reaction force of pulling the traveling suitcase so that a user can conveniently pull the traveling suitcase, hence conforming to human engineering.

2. Components such as the soft component 41 and the resilient element 42, which are made of soft material such as rubber, and the felly portion 402, which is made of colloid material, are exploited to further effectively absorb vibration energy generated when the roller 40 rolls on uneven ground, thereby enhancing shock-absorbing effect of the traveling suitcase 50 and lengthening lifetime of use of the roller 40.

3. The whole shock-absorbing effect is enhanced so that valuable articles in the traveling suitcase 50 can be effectively protected.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A shock-absorbing caster structure of traveling suitcase, comprising:
a caster shell seat having a receiving space therein and fixedly disposed at a bottom edge of a rear side of a traveling suitcase;
a roller pivotal seat received in said receiving space of said caster shell seat, said roller pivotal seat having an arc-shaped top plate, a left side plate, and a right side plate, said left and right side plates being bent from two sides of said arc-shaped top plate, pivotal holes being respectively disposed at a top of said arc-shaped top plate and on said left and right side plates, said pivotal hole at the top of said arc-shaped top plate matching a pivot to pivotally join said caster shell seat;
a roller comprising a hub portion and a felly portion disposed at a periphery of said hub portion, said hub portion having a central hole, said central hole matching a pivot to be pivotally joined at said pivotal holes of said left and right side plates of said roller pivotal seat; and
a soft component or resilient body, one side thereof being joined on said arc-shaped top plate of said roller pivotal seat, the other side thereof abutting against an inner edge of said caster shell seat.

2. The shock-absorbing caster structure of traveling suitcase as claimed in claim 1, wherein said caster shell seat has a plurality of projective poles thereon matched with screws or rivets to fixedly disposed said caster shell seat at the bottom edge of the rear side of the traveling suitcase.

3. The shock-absorbing caster structure of traveling suitcase as claimed in claim 1, wherein a protuberance is disposed at the top of said arc-shaped top plate of said roller pivotal seat, and said protuberance has a pivotal hole to be passed through by said pivot.

4. The shock-absorbing caster structure of traveling suitcase as claimed in claim 1, wherein a mobile clamping groove is disposed on said arc-shaped top plate of said roller pivotal seat to clamp two sides of said soft component.

5. The shock-absorbing caster structure of traveling suitcase as claimed in claim 1, wherein a hollow flange is formed at a center of said soft component, said flange abutting against an inner edge of said caster shell seat, said hollow flange receiving a resilient element to enhance shock-absorbing effect.

6. The shock-absorbing caster structure of traveling suitcase as claimed in claim 1, wherein said resilient body is a spring.
